(19) United States
(12) Patent Application Publication
(10) Pub. No.: US 2007/0245379 A1
(43) Pub. Date: Oct. 18, 2007

(54) Personalized summaries using personality attributes

(75) Inventor: Lalitha Agnihortri, (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics, N.V., Eindhoven (NL)

(21) Appl. No.: 11/629,633

(22) PCT Filed: Jun. 17, 2005
(86) PCT No.: PCT/IB05/52008

§ 371 Date: Dec. 15, 2006

Related U.S. Application Data
(60) Provisional application No. 60/580,654, filed on Jun. 17, 2004.
(60) Provisional application No. 60/639,390, filed on Dec. 27, 2004.

(51) Int. Cl. H04N 5/445; H04N 7/10; H04N 7/025; G06F 13/00

(52) U.S. Cl. 725/46; 725/34

(57) ABSTRACT

A method and system for generating a personalized summary of content for a user is provided that include determining personality attributes of the user; extracting features of the content; and generating the personalized summary based on a map of the features to the personality attributes. The features may be ranked based on the map and the personality attributes, where the personalized summary includes portions of the content having the features which are ranked higher than other features. The personality attributes may be determined using Myers-Briggs Type Indicator test, Merrill Reid test and/or brain use test, for example.

The present invention generally relates to methods and systems to personalize summaries based on personality attributes.

Recommenders are used to recommend content to users based on the their profile, for example. Systems are known that receive input from a user in the form of implicit and/or explicit input about content that a user likes or dislikes. As an example, co-pending, commonly assigned U.S. Pat. No. 6,727,914, filed Dec. 17, 1999, by Gutta et al., entitled, Method and Apparatus for Recommending Television Programming using Decision Trees, incorporated by reference as if set out fully herein, discloses an example of an implicit recommender system. An implicit recommender system recommends content (e.g., television content, audio content, etc.) to a user in response to stored signals indicative of a user's viewing/listening history. For example, a television recommender may recommend television content to a viewer based on other television content that the viewer has selected or not selected for watching. By analyzing viewing habits of a user, the television recommender may determine characteristics of the watched and/or not watched content and then tries to recommend other available content using these determined characteristics. Many different types of mathematical models are utilized to analyze the implicit data received together with a listing of available content, for example from an EPG, to determine what a user may want to watch.

Another type of known television recommender system utilizes an explicit profile to determine what a user may want to watch. An explicit profile works similar to a questionnaire wherein the user typically is prompted by a user interface on a display to answer explicit questions about what types of content the user likes and/or dislikes. Questions may include: what is the genre of content the viewer likes; what actors or producers the viewer likes; whether the viewer likes movies or series; etc. These questions of course may also be more sophisticated as is known in the art. In this way, the explicit television recommender builds a profile of what the viewer explicitly says they like or dislike.

Based on this explicit profile, the explicit recommender will suggest further content that the viewer is likely to also like. For instance, an explicit recommender may receive information that the viewer enjoys John Wayne action movies. From this explicit input together with the EPG information, the recommender may recommend a John Wayne movie that is available for viewing. Of course this is a very simplistic example and as would be readily understood by a person of ordinary skill in the art, much more sophisticated analysis and recommendations may be provided by an explicit recommender/profiling system.

Other recommender systems are known, for example, co-pending, commonly assigned U.S. patent application Ser. No. 09/666401, filed Sep. 20, 2000, by Kurapati et al., entitled Method and Apparatus for Generating Recommendation Scores Using Implicit and Explicit Viewing, discloses an example of an implicit and explicit recommender system. U.S. patent application Ser. No. 09/627139, filed Jul. 27, 2000, by Shaffer et al., entitled Three-way Media Recommendation Method and System, discloses an example of an implicit, explicit and feedback based recommender system. U.S. patent application Ser. No. 09/953385, filed Sep. 10, 2001, by Shaffer et al., entitled Four-Way Recommendation Method and System Including Collaborative Filtering, discloses an example of an implicit, explicit, feedback and collaborative filtering based recommender system. Each of the systems disclosed in the above-noted patent applications are incorporated by reference as if set out fully herein.

There are also various well known methods for content analysis and classification using, as disclosed in U.S. Pat. No. 6,754,389 B1 to Dimitrova et al., US 2003/0031455A1 to Sagar, and WO 02/096102 A1 to Trajkovic et al. (U.S. patent application Ser. No. 09/862,278, filed May 22, 2001), assigned to Koninklijke Philips Electronics N.V., which are incorporated herein by reference in their entirety.

Conventional recommenders recommend content after determining the user profiles implicitly or explicitly, such as determining that certain features, such as feature X in video, feature Y in audio, and feature Z in text of a content are important to a particular user. A particular content may be analyzed to determine or extract such features, and recommend the program based on the detected features and user profile, or generate a summary of the content by extracting the XYZ features that are important to the user as determined from the user profile. For example, it is important for this particular user to see faces (X=face) in a video content, hear speech (i.e., not silence, e.g., Y=speech) in an audio content, and see particular names or words in the text (Z=text) of the content, or any other classification. Thus, a program or program summary that includes features XYZ (i.e., faces, sound and text) is provided or recommended to such a user. In conventional recommenders or summary generators, the features XYZ are fixed. The inventors have realized that there is a need to generate variable features X′Y′Z′ that are not fixed or constant since people have preferences. Thus, the features X′Y′Z′ to be extracted from a content for generating a summary or recommending the content are personalized based on personality types or traits of the user(s).

People often do not know what is important to them in a program, or what they want to see/hear in the program, such as whether faces, text, or type of sound is important to them. Accordingly, a test is used to determine indirectly user preferences. Explicit recommenders ask questions to determined user preferences, which often takes many hours. Implicit recommenders use profiles of similar users or determined user preferences based on the user's history. However, either seed/similar profiles are needed or the user's history.

Methods to analyze personality types of people abound. Methods to extract various features from video, audio and closed caption are well known. Conventional recommenders are based on high level features such as review of content by critics, genre and type of content, and do not use or recommend based on low level content features at the bit/byte level for example. People's consumption of media (TV programs, movies, etc.) depends on their personality. In order to determine what kind of programs people might like and what to include in the summaries, the inventors have noted that it is advantageous to map the personality traits to low and mid level features that can be derived from the video watched by a person for example. Each personality group has a different map, thus the features XYZ are personalized based on the user's personality traits.

Conventional systems derive a number of features from video and assume that different features have a certain (fixed) importance for the general population. For example, faces are important and must be shown in summaries. However, there is no general classification based on personality traits to determine what segments are actually of interest to different users. Thus, conventional systems do not provide a personalized content summary or content summary based on the user's personality traits.

According to one embodiment of the present invention, a method is provided for generating a personalized summary of content for a user comprising determining personality attributes of the user; extracting features of the content; and generating the personalized summary based on a map of the features to the personality attributes. The method may further include ranking the features based on the map and the personality attributes, where the personalized summary includes portions of the content having the features which are ranked higher than other features. The personality attributes may be determined using Myers-Briggs Type Indicator test, Merrill Reid test, and/or brain-use test, for example.

The generation of the personalized summary may include varying importance of segments of the content based on the features preferred by persons having personality attributes as determined from the map, which includes an association of the features with the personality attributes and/or a classification of the features that are preferred by persons having particular personality attributes.

The map may be generated by test subjects taking at least one personality test to determine personality traits of test subjects; observing by the test subjects a plurality of programs; choosing by the test subjects preferred summaries for the plurality of programs; determining test features of the preferred summaries; and associating the personality traits with the test features which may be in the form of a content matrix which is analyzed using factor analysis, for example.

Additional embodiment include a computer program embodied within a computer-readable medium created using the described methods which also include a method of recommending contents to a user comprising determining personality attributes of the user; extracting content features of the contents; applying the personality attributes and the content features to a map that includes an association between the personality attributes and the content features to determine preferred features of the user; and recommending at least one of the contents that includes the preferred features.

A further embodiment includes an electronic device comprising a processor configured to determine personality attributes of a user of content; extracting features of content; and generating personalized summary based on a map of the features to the personality attributes.

The following are descriptions of illustrative embodiments of the present invention that when taken in conjunction with the following drawings will demonstrate the above noted features and advantages, as well as further ones. In the following description, for purposes of explanation rather than limitation, specific details are set forth such as the particular architecture, interfaces, techniques, etc., to provide an illustration of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present invention that is defined by the appended claims. In the figures, like parts of the system are denoted with like numbers.

The invention is best understood in conjunction with the accompanying drawings of illustrative embodiments in which:

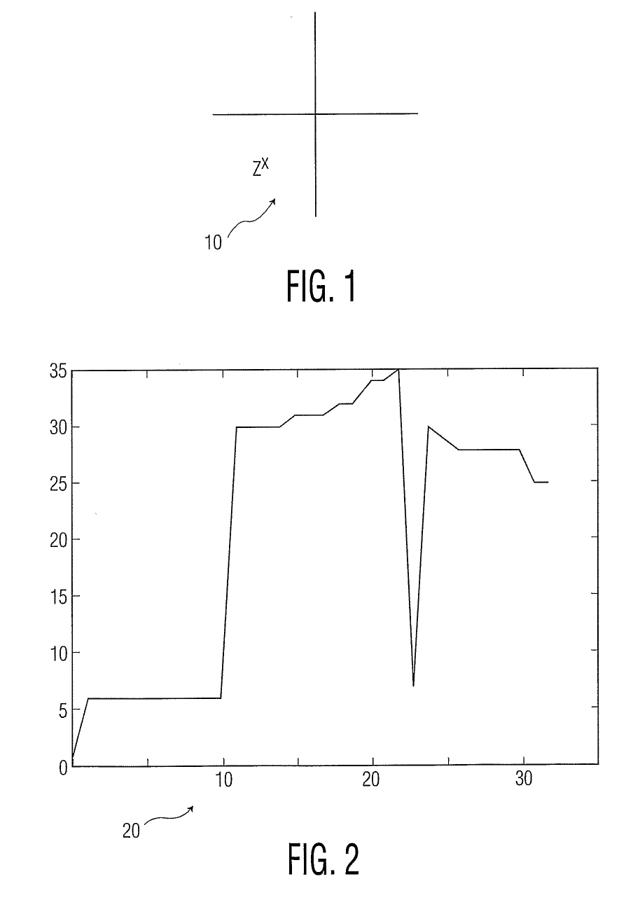

FIG. 1 shows a two-dimensional personality map according to the Merrill Reid test;

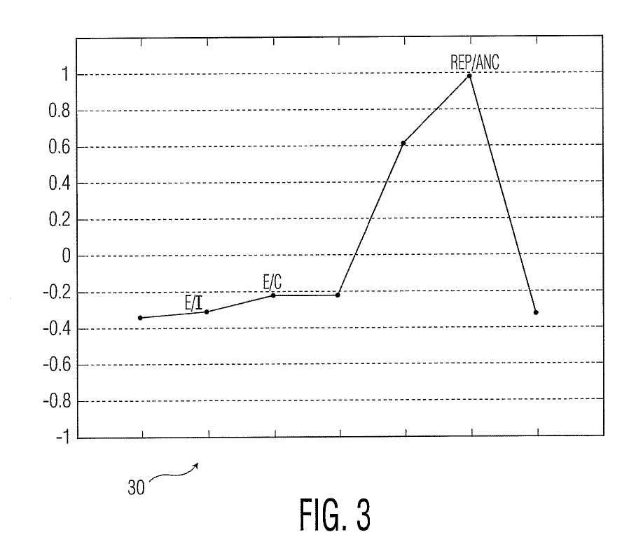

FIG. 2 shows a histogram of video time distribution;

FIG. 3 shows the final significant factor for news videos with limited features;

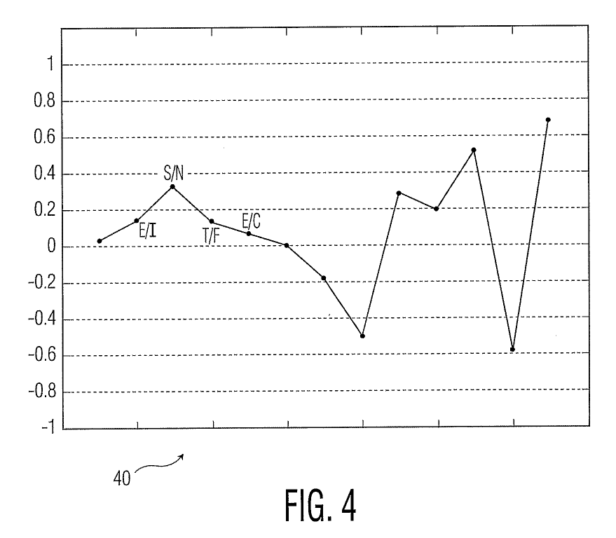

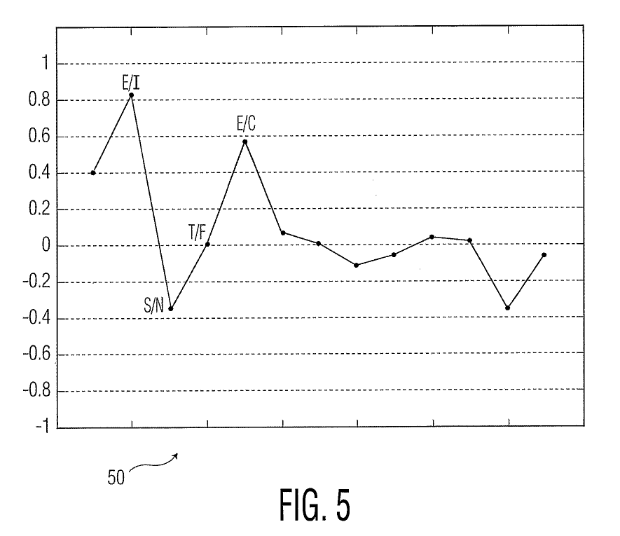

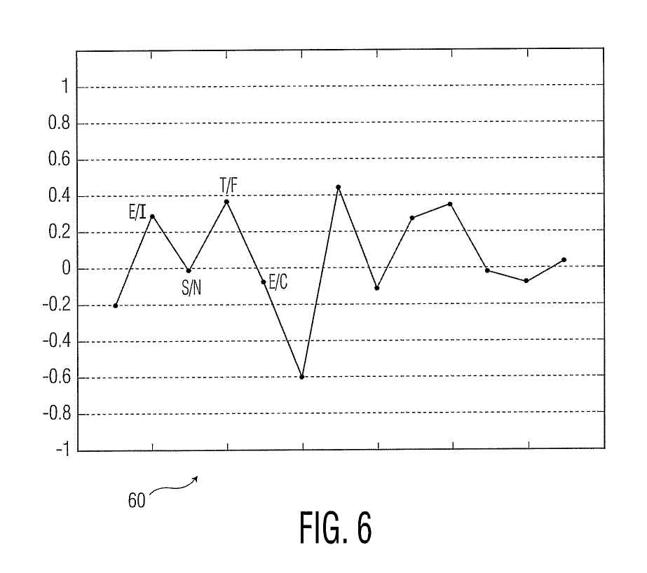

FIGS. 4-6 respectively show three final factor analysis vectors for talk shows;

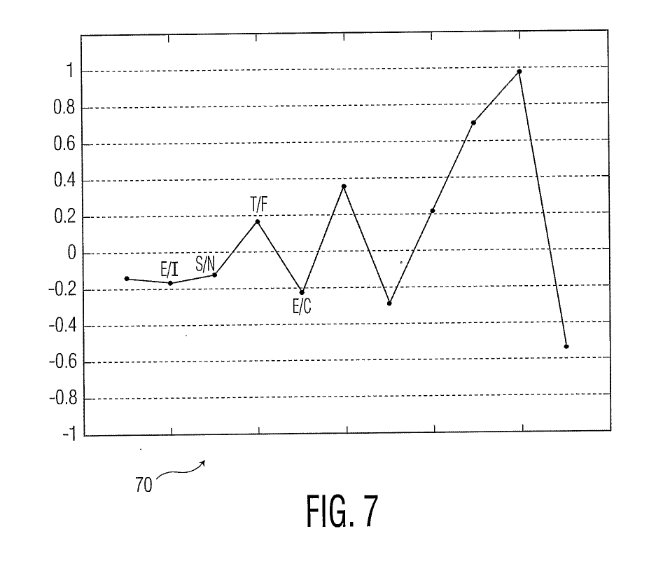

FIG. 7 shows the final factor analysis vector for music video data;

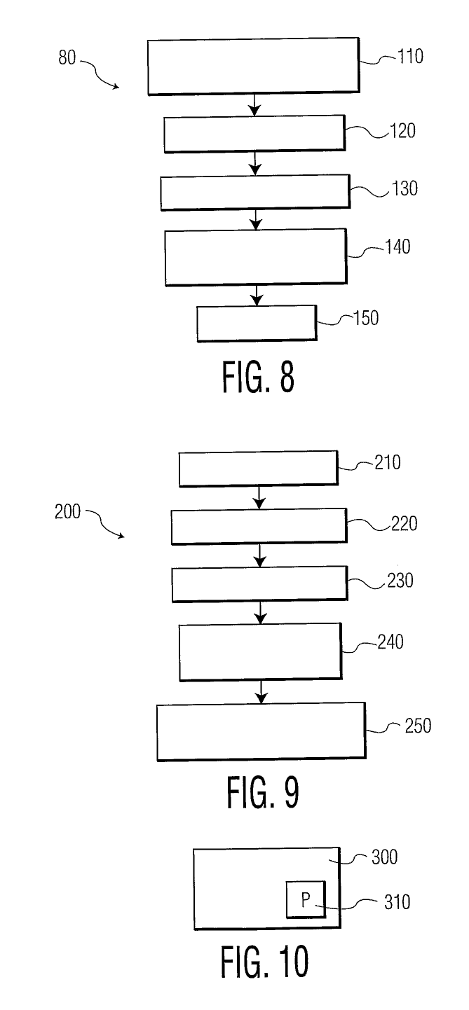

FIG. 8 shows a flow chart for recommending content;

FIG. 9 shows a method for generating the map; and

FIG. 10 shows a system for recommending content or generating summaries.

In the discussion to follow, certain terms will be illustratively discussed in regard to specific embodiments or systems to facilitate the discussion. As would be readily apparent to a person of ordinary skill in the art, these terms should be understood to encompass other similar known terms wherein the present invention may be readily applied.

For brevity, various details which are not directly related to the present invention, such as different content detection techniques are not included herein, but are well known in the art, such as various recommender systems. In addition, each type of content has ways in which it is observed by a user. For example, music and audio/visual content may be provided to the user in the form of an audible and/or visual signal. Data content may be provided as a visual signal. A user observes different types of content in different ways. For the sake of brevity, the term content is intended to encompass any and all of the known content and ways content is suitably viewed, listened to, accessed, etc. by the user.

One embodiment includes a system that takes the abstract terms from the personality world and maps it into the concrete world of video features. This enables classifying content segments as being preferred by different personality types. Different people, therefore, are shown different content segments based on their preference(s)/personality traits.

Another embodiment includes a method of using personality traits to automatically generate personalized summaries of video content. The method takes user personality attributes, and uses these personality attributes in a selection algorithm that ranks automatically extracted video features for the generating a video summary. Once the personality traits are extracted from the user, the algorithm can be applied for any video content that the user have access to at home or while away from home.

The personality traits are combined or associated with video features. This enables generation of personalized multimedia summaries for users. It can also be used to classify movies and programs based on the kind of segments users have, and to recommend to users the kind of programs they like.

There are many well-known personality tests. Typically, a personality test offers a number of questions to a user and maps personalities to an N dimensional space. Myers-Briggs Type Indicator (MBTI) maps personality to four dimensions: Extraverts vs. Introverts (E/I), Sensors vs. Intuitives (S/N), Thinkers vs. Feelers (T/F), and Judgers vs. Perceivers (J/P). Another personality test known as the Merrill Reid test maps users onto a two dimensional space: Ask vs. Tell (A/T) and Emote vs. Control (E/C) 10 as shown in FIG. 1, where a personality Z falling in the third quadrant for example, would include traits prone to asking questions and being emotional ( as opposed to being in control) and prefer telling (instead of asking). Different people cluster into different points in this 4D or 2D space, for example.

A third personality test includes one performed by executing a program readily available, such as on the web (e.g. from http://www.rcw.bc.ca/test/personality.html) known as “brain.exe” herein referred to as the brain-use test. The program asks a series of 20 questions. At the end, it determines whether the left or the right side of the brain is used more, and what personality traits a user may have, such as perceiving things through visual or auditory sensation.

Mapping to Content

Based on the characteristics of the different dimensions of personality spaces, a mapping to content is generated. For example, “have high energy” characteristic of Extravert can possibly map to “fast pace” in video analysis. In order to map to content, a list of possible content features (^{b}Fₐ) is generated that can be detected using audio, video and text analysis, for example. Here a is the feature number and b are the possible values that the feature can take. These content features include classification such as the following features a equal 1 to 8, where feature 1 (i.e., a=1) has 2 possible values b for example:

| Value of a | |
|---|---|
| 1 | Indoor vs. outdoor (²F₁), |
| 2 | anchor vs. reportage (²F₂), |
| 3 | fast vs. slow (²F₃), |
| 4 | factual vs. abstract (²F₄), |
| 5 | positive emotion vs. negative emotion vs. neutral (³F₅), |
| 6 | problem statement vs. conclusion vs. elaboration (³F₆), |
| 7 | violence vs. non-violence (²F₇), |
| 8 | audio classification into speech, music, noise, |
| | silence etc. (⁹F₈), and so on. |

In all, m features are used to form a content matrix C_{k×m} as shown in Table 1. For each time interval (e.g., seconds, fraction of a second, minutes or any other granularity) t₁ through tₖ, there is a vector F which has m-dimensions. For content with k-time instances (tₖ), the content matrix has k by m dimensions. For example, t₁ may be from zero to one seconds, t₂ may be from one to two seconds etc.

TABLE 1
Content Matrix C_{k×m}

Content Features

| Time Instance | ²F₁ | ²F₂ | ²F₃ | ^{a}Fₘ |
|---|---|---|---|---|
| t₁ | | | | |
| t₂ | | | | |
| t₃ | 1 | 0 | | |
| t₄ | | | | |
| t₅ | | | | |
| tₖ | | | | |

Entries (such as 0's and 1's ) of the content matrix C_{k×m} (Table 1) are derived from content analysis. The entries of ones and zeros in Table 1 indicate whether the feature ^{b}Fₐ is present or not present, respectively, for the time instance tₖ. For example, a person may chose as a summary the segment of the content for time instances from t₃ seconds to t₅ seconds of the content, which may be a talk show program for example. Illustratively, during time t₃ seconds, indoor vs. outdoor (²F₁) is 1 indicating this feature exists in the content segment at time interval t₃, and anchor vs. reportage (²F₂) is 0, indicating this feature does exists at time interval t₃. The entries (i.e., presence or absence of ^{b}Fₐ) of the content matrix C_{k×m} (Table 1) for the chosen summary segment between t₃ and t₅ are analyzed to find a cluster pattern of the content features (^{b}Fₐ).

Next, it is described the manner in which how to map the above content matrix C_{k×m} to a subspace or union of areas in the Personality space (P_space). For example, once it is known that certain personality types, e.g., extroverts, like certain content features (^{b}Fₐ), such as ‘anchor’ (and/or ‘outdoor’ and/or any other feature(s)), then the beginning of a video content, which typically includes the ‘anchor’ is given more weight, thus varying the importance of the content feature (e.g., of ‘anchor’) to better personalize and recommend content and/or summaries that are preferred by such particular users who are extroverts for example.

Personality Mapping Discovery

In order to form the content to personality mapping, a personality test is given to a number of people and their personality mapping is collected. Then, the following steps are performed:

I. each story is segmented into segments that come with a clear label;

II. test subjects choose segments that summarize the story best for them; and

III. based on the above one of the four following outcomes is possible:

1. There is a one to one mapping between choice of content segments and personality types.

2. There is a one to one mapping between choice of content segments for some personality types and one to many for others.

3. There is many to many mapping between choice of content segments and all personality types.

4. For each person there is a c+ and c− clustering for the content and we can infer the content elements and media elements preferences for each individual who takes the test.

Applying Detailed User Preferences

There exists c+ and c− clustering from any of the possible outcomes 1 to 4 noted above on either a personality level (outcomes 1 and 2) or on a person (individual) level (outcomes 3 and 4). These preferences inferred from the clustering are expressed as filters on incoming content. A query is formulated that has the same dimensionality and the feature vector F. The query Q(f₁, f₂, f₃ . . . fₘ) is now applied to the incoming new content. The content matrix C_{k×m} with is convolved with Qₘ. In addition, expectation maximization is performed in order to have uniform segments. The output of the above is a weighted one-dimensional (1D) matrix that gives importance weights to different segments within the content. The segments with highest values are extracted to be presented in a personalized summary.

Methodology

In order to establish the mapping between personality attributes and video features a series of user test is performed. The following describes the methodology and the results from this user test.

1. User Tests for Gathering Personalities and Preferences

User tests are performed in order to uncover patterns of personality to content analysis feature mapping. Personality traits were obtained from users through questions of tests. Next, the users were shown a series of video segments and then had to choose the most representative video, audio, and image that summarized the content best for them. In all, users were shown eight news stories, four music videos, and two talk shows.

User tests were performed in order to uncover patterns of personality to content analysis feature mapping. “Buyers are Liars!” This is a well-known phrase to realtors who are approached by buyers with a wish list of things they want to have in a house that they would like to buy. This concept is also true from the summary point of view. If given an option, the users would like to see the whole world in the summary. Thus, to deal with this issue, users were not directly asked what is it that the users would like to see. Instead, users were forced to answer questions in order to proceed. The answers provided the personality traits and preferred summaries of the users.

1.1 Testing Paradigm

Since asking users whether they would like to see faces over text in the video does not provide reliable information, instead, users were presented with different summaries for a particular content, and asked to pick the summary of their choice. Next, the video features in the selected content segment (i.e., selected summary) were analyzed in order to determine user preferences. The users were shown a series of videos and then asked to choose the most representative video, audio, and image that best summarized the content for them. For each video, two to three possible summaries of video and audio were presented to the user for selection. The text portion presented to the user for selection was the same as the audio potion and they were shown together in a presentation for selection. If the users did not like any of the summaries that were provided, they could enter the start and end timestamps of a segment of their own choice. The users were also asked to select one still image from three or four pre-selected still images. As noted above, users were shown eight news stories, four music videos, and two talk shows.

For the personality selection, users were shown a list of traits for each pair of opposing traits and they selected one trait or the other based on their own assessment of their personality. Thus, the users were not given a personality test in which a user is asked a series of questions and then their personality is assessed. This method using a list of pairs (or more) of personality traits was followed for the four traits of Myer-Briggs Type Indicator (i.e., E/I, S/N, T/F & J/P), and for the two traits of Merrill Reid (i.e, A/T & E/C). For the two trait of Brain.exe (i.e., preferring visual or auditory sensation), the users went through a traditional test of answering a series of questions, as well as estimating whether they are right or left brained and whether they prefer visual or auditory sensation.

Before the personality & content viewing test started, the users were given a brief introduction (e.g., under five minutes) of the task they were expected to do. No mention of relating personality to summary selection was made until after the session was over.

1.2 User Study

Questions related to what the users prefer to see in the summary were asked through a web site that the users stepped through. In the first page, users were asked to enter personal information, such as their name, age, gender, and email address. Next, users navigated to the personality information pages. In the first two pages, users selected their personality features for Myers Briggs Type Indicator and Merrill Reid. Users read through a list in order to make their choices. For MBTI, users chose Extravert vs. Introvert (E/I), Sensation vs. Intuition (S/N), Thinker vs. Feeler (T/F), and finally Judger vs. Perceiver (J/P). For Merrill Reid, the users selected Ask vs. Tell (A/T) and Emote vs. Control (E/C). For the third personality test, the users were asked to download an executable program known as “brain.exe¹” and answer the twenty questions in the test. At the end of the test, they wrote down their scores that were computed by the program. This score was entered on the third personality test page. The brain.exe program was downloaded from the web after searching for various personality tests. For each of the personality tests, a brief introduction was given at the beginning of the page.

1.3 Summary Selection

After navigating through these personality pages, subjects or users were told what to expect for the rest of the session. Subjects first watched the original video in its entirety. On the right, the transcript of the video was presented. The users then scrolled down to see two or three pre-selected video only summaries. These video summaries did not contain any audio and presented a contiguous portion of the video that summarized the video. The users could either choose one of these videos summaries, or could specify their own video segment or summary. In this way, subjects selected summaries for eight news stories, four music videos, and two talk shows. If the users failed to enter some information, they were forced to go back to the previous page and enter the required information.

2. Analysis of User Test Data for Relationships

Many users participated in the user tests. In order to analyze the data, cumulative data analysis is used such as plotting histograms and visual patterns. The data collected from a user test is laid out as follows: The personality data of a user followed by the audio, video, and image summary selected by the user for each of the news stories, music videos, and talk shows.

The personality data itself includes the following: sex, age, four rows of Myers Briggs Type Indicator, two rows of Maximizing Interpersonal Relationships, and finally two rows for {brain.exe} comprising auditory and left orientation.

The summaries selected for the content (i.e., the selected summary or content segment) is laid out as follows for each video segment:

1. The video selection number (1, 2, 3, 4, or 5), where 1-4 are 4 summaries provided to the user for selection, and 5 indicates people had chosen their own video segment/summary other than the four presented summaries 1-4.

2. After the video selection number, the begin and end times of the selected segments/summaries in seconds is included.

3. The audio summary selection number (1-5, similar to the video summary) is also followed by the begin and end times.

4. Finally a number (1, 2, or 3) for the image selected as an image summary, which is for example a single still image.

The first step in our analysis was to perform cumulative analysis and visual inspection of data in order to find patterns.

2.1 Histograms Analysis

Histograms are plotted of responses for selection of videos to determine how much variability exists in the selection of audio, video and image segments. For example, if the histograms indicated that everybody consistently selected the second video portion and the first audio portion for a given video segment, then there is no need for personalized summarization at all, since such one summary (including the second and first video and audio portions respectively) applies to all users. Also a histogram was plotted of the actual time when the videos were selected.

FIG. 2 shows a histogram 20 of video time distribution, where the x-axis is time in seconds for video selection in a 30 second news story presented to users. The y-axis of the histogram 20 is the number of times or number of users that selected the associated time segment of the video, which in this case is a news story for example. As seen for the histogram 20, 6 users selected the video portion approximately between 1 to 10 seconds of the news story; 30 users increasing to 35 users selected the video portions shown between 10 seconds of the 2 seconds of the news story, and 30 users decreasing to 25 users selected the video portions shown between approximately 23 seconds of the 30 second news story.

2.2 Principal Component Analysis and Factor Analysis

Principal component analysis (PCA) involves a mathematical procedure that transforms a number of (possibly) correlated variables into a (smaller) number of uncorrelated variables called principal components. The first principal component accounts for as much of the variability in the data as possible, and each succeeding component accounts for as much of the remaining variability as possible.

Another very similar analysis is factor analysis which is a statistical technique used to reduce a set of variables to a smaller number of variables or factors. Factor analysis examines the pattern of inter-correlations between the variables, and determines whether there are subsets of variables (or factors) that correlate highly with each other but that show low correlations with other subsets (or factors).

The “princomp” command on MATLAB is executed and the resulting Eigen vectors plotted to see which Eigen values are significant. Next, the principal components associated with these Eigen values are plotted.

Further, the “factoran” function was used in MATLAB that computes the maximum likelihood estimate (MLE) of the factor loadings matrix lambda in the factor analysis model
X_{dx1}=μ_{dx1}+λ_{dxt}fₜₓ₁+e_{dx1}

where X is an observed vector of length d (where d=q+w in this case, where personality traits are from 1 to q, and video features are from 1 to w), μ is a constant vector of means, λ is called factor loadings matrix, f is a vector of independent, standardized common factors, and e is a vector of independent specific factors.

In order to find significant patterns in the mapping between personality and content analysis features, extensive principal component and factor analysis was performed on the data.

2.2.1 Content Analysis Features

As an illustrative example, content from three different genres is used for content analysis, such as news, talk shows, and music videos. Of course, any other or additional genre(s) may be used such as reality shows, cooking shows, how-to-do shows, and sports related shows.

In this section, further details are provided related to the various video, audio (text), and image features that were generated for the input video. The following video features were generated for news video, where some video features ere automatically generated while other video features were manually generated by an analyst viewing and choosing at least one of the following video features as being associated with the particular video segment:

1. Emotion

2. Number of Faces

3. Number of text lines

4. Graphics/None

5. Interview/Monologue

6. Anchor/Reportage (Anc/Rep)

7. Indoor/Outdoor (In/Out)

8. Mood

9. Personality

10. Name of Personality

11. Dark/bright

The above features were also generated for the images (that is single still images, as compared to video segments of a certain length of time, e.g., one second) that were presented to the users.

For the text that was spoken during the shown content (e.g., news videos of 30 seconds in length), a ground truth was generated that included the following features for news videos:

1. Category

2. Speaker

3. Statement type

4. Past/Future

5. Facts/fiction/other

6. Personal/Professional

7. Names

8. Places

9. Numbers

For talk shows the same text features as above were used. However, a slightly different set of video features were used as follows:

1. Number of Faces

2. Number of text lines

3. Graphics/None

4. Interview/Monologue/Scenery

5. Host/Guest

6. Indoor/Outdoor

7. Personality

8. Name of Personality

9. Dark/bright

For music videos, a different set of audio and video features were used which are enumerated below. Video features that were explored included:

1. Number of Faces

2. Number of text lines

3. Graphics/None

4. Singer/Band

5. Indoor/Outdoor

6. Personality

7. Name of Personality

8. Dark/bright

9. Dance/No Dance

Audio/text features that were explored included:

1. Chorus/Other

2. Main Singer/Others

As can be seen, a different set of features was used for each of the three genres (i.e., for the news stories, talk shows, and music videos), and hence the patterns were analyzed independently for each of the genres.

2.2.2 Concept Value Matrix

A concept value matrix was created for each of the genres which was analyzed using principal component analysis. In the matrix, there was one row for each of the users ‘u’ who participated in the user test. The initial columns were derived from the personality tests ‘P’ that the user completed.

Illustratively, 10 personality features may be used (Pᵤ₁ to P_{1g}, where g=10), such as 4 personality features obtained from MBTI personality test, 2 personality features obtained from AATEC personality tests, 2 personality features obtained from Brain.exe personality tests. In addition, age and gender were also used for a total of 10 personality features (g=10). The next columns (Vᵤ₁ to V_{uw}) includes cumulative number for each of the features chosen by the user, such as 9 video features Vᵤ₁ to V_{uw}, where w=9 for the 9 video features noted above for music videos. For example, where each user (e.g., out of 52 users, u=52) chose summaries for the 8 news stories, 5 out of the 8 chosen summaries included V₁₃ (which is the graphic/none feature), then the value of V₁₃ is the concept value matrix below (Table 2) will be 5.

A matrix of (number of user)*(total personality features+content analysis features) was obtained for each of the genres.

Table 2 is an illustrative concept value matrix which is then analyzed to find patterns:

TABLE 2

| | | | | | | | |
|---|---|---|---|---|---|---|---|
| P₁₁ | P₁₂ | . . . | P_{1g} | V₁₁ | V₁₂ | . . . | V_{1w} |
| P₂₁ | P₂₂ | . . . | P_{2g} | V₂₁ | V₂₂ | . . . | V_{2w} |
| . | . | . | . | . | . | . | . |
| . | . | . | . | . | . | . | . |
| . | . | . | . | . | . | . | . |
| Pᵤ₁ | Pᵤ₂ | . . . | P_{ug} | Vᵤ₁ | Vᵤ₂ | . . . | V_{uw} |

In the above matrix, ‘P’ stands for personality features. There are ‘q’ personality features. ‘V’ stands for video analysis features. There are ‘w’ video analysis features. The total number of users that participated in the test is ‘u’. So the concept matrix is of (u, X, q+w) dimension.

Illustratively, all the personality columns have a range from ‘−1’ to ‘1’. As for the most part, nominals are used, where ‘−1’ would mean NOT of ‘1’. For the column that contained personality values for gender, ‘1’ represents Female and ‘−1’ represents Male. For the four MBTI personality attributes, ‘1’ represents Extravert, Sensation, Thinker, and Judger while ‘−1’ represents Introvert, Intuition, Feeler, and Perceiver. For the two Merrill Reid personality attributes, ‘1’ represents Ask and Emote while ‘−1’ represents Tell and Control. The Brain.exe data that originally ranged from 0-100 was normalized by subtracting 50 from the raw numbers and dividing them by 50. This ensured that a completely auditory person has a score of ‘1’ and a completely visual one has a score of ‘−1’. Similarly a left-brained person has a score of ‘1’ and a right-brained person has a score of ‘−1’. The age data was first quantized into 10 groups based on the subdivisions used for collecting marketing data. The following age groups slabs used were: 0-14, 15-19, 20-24, 25-29, 30-34, 35-39, 40-44, 45-49, 50-54, 55-60, and 60+. Then in order to normalize them from ‘−1’ to ‘1’, the slabs were mapped to −1.0 (0-14), −0.8 (15-19) and so on till ‘1’ (for the age group 60+). The idea is to be able to say younger vs. older users in case patterns arise.

For the video, audio, and image features, the encoding is generated as follows. For each of the summary segments, the ground truth data is analyzed to find the features in that segment. For example, if text is present in 8 seconds of a 10 seconds segment, then a vote of 0.8 was added to the text presence feature. Similarly if a user chose five anchor segments, and three reportage segments, a value of five was placed in the “anchor/reportage” column V_{uw} in Table 2.

In the following sections, a further description is provided related to the factor analysis of the concept value matrices that was performed in order to uncover patterns of interaction between personalities and content analysis features.

2.2.3 News Patterns

For news, the ten personality features and thirty-three video features were used.

The columns of the concept value matrix shown in Table 2 were as follows:

(Personality Features) Female, Age, E/I, S/N, T/F, J/P, A/T, E/C, Auditory, Left;

(Visual Features) Faces, Text, Graphics, Rep/Anchor, Out/In, Happy/Neutral, Dark/Bright;

(Audio/Text Features) Explanation, Statement, Intro, Sign-in, Sign-off, Question, Answer, Past, Present, Future, Fact/Speculation, Prof/Personal;

(Image Features) NoFaces, OneFace, ManyFaces, NoText, OneText, ManyText, Graphics/None, Interview, Scene, Reporting, Rep/Anc, Out/In, Dark/Bright.

Certain features (columns of the concept value matrix shown in Table 2) were eliminated such as those that showed little or no variation (columns with variance close to zero), as well as columns with linear dependency were eliminated. Next, performing a factor analysis of this matrix resulted in three factors evaluating the stats that the “factoran” function of MATLAB returns. The three factors were further reduced to two factors. Next, features that showed up only in video features or only in personality features of the factors were eliminated one by one. For example, if in a factor only two features are significant and they both are a personality feature, then it means that one predicts another and thus one of the feature can be eliminated.

The following features were eliminated since, for example, they resulted in unique variances that are close to zero: Age (P), Thinker/Feeler (P), Outdoor/Indoor(V), Dark/Bright (V), Introduction (T), Reportage/Anchor (I), NoText (I), OneText (I), Graphics (I), Scene (I), Outdoor/Indoor (I), and Dark/Bright (I). After eliminating such features, one significant factor was left as shown in FIG. 3 which shows the final significant factor (shown as reference numeral 30 in FIG. 3) for news videos with limited features.

Referring to FIG. 3, a threshold of +0.2 and −0.2 was used. The first three data points, namely, Female/Male, Extraverts/Introvert, and Emote/Control are all below the threshold of −0.2 and thus are given the value of −1, as will be explained in greater detail below in connection with describing an algorithm used for mapping between personality and feature space. Thus, the first three data points indicate, Male, Introvert and Control. The next three data points are the video features in a 10 second summary of the 30 second news video, namely, Faces, Text, and Reportage, having values of −1, +1 and +1, respectively, indicating the selected summary by the user(s) did not contain Faces, but contained Text and Reportage. The last data point in FIG. 3 is a feature of a still image chosen as a summary, namely, Reporting with a value of −1 (since below the threshold of ‘−0.2’), indicating that the still image chosen by users who are Male, and have Introvert and Control personalities in the summary did not include Reporting.

2.2.4 Talk Show Patterns

In order to perform analysis of patterns for talk shows, again the concept values matrix was used. The columns of the concept value matrix shown in Table 2 were as follows:

(Personality Features) Female, Age, E/I, S/N, T/F, J/P, A/T, E/C, Auditory, Left;

(Visual Features) ‘Faces(Present/Not present)’, ‘Intro’, ‘Embed’, ‘Interview’, ‘Host’, ‘Guest’, ‘HostGuest’, ‘Other’;

(Audio/Text Features) ‘Explanation’, ‘Statement’, ‘Intro’, ‘Question’, ‘Answer’, ‘Past’, ‘Present’, ‘Future’, ‘Speaker (Guest/Host)’, ‘Fact/Spec.’, ‘Pro/Personal’; and

(Image Features) ‘NumFaces (More than one/one)’, ‘Intro’, ‘Embed’, ‘Interview’, ‘Host’, ‘Guest’, ‘HostGuest’.

Similar to the News pattern analysis, certain features were eliminate that are either low in variance or were linearly dependent on other features. The eliminated features having a low variance include the following features (Brain features (Auditory (P) and Left (P)), Embedded Video (V), Explanation (T), Question (T), Answer (T), Future (T)). The eliminated features having a linear dependent on other features include (Guest (V), Interview (I), HostGuest (I), and Host (I)).

Other features were also eliminated due to factor analysis pulling out features as individual factors or due to unique variances becoming zero: Ask/Tell (P), Faces (V), Introduction (V), HostGuest (V), Introduction (T), Statement (T), Present (T), Fact/Speculation (T), Embed (I). After factor analysis of talk show data, three final factor analysis vectors 40, 50, 60 for the talk shows remained at the end of the elimination as shown in FIGS. 4-6.

Referring to FIG. 4 for example, the first 5 data points of the first factor analysis vector 40 (for the data from the talk shows) are related to the user, namely ‘Sensors vs. Intuitives or S/N’=+1 (Sensors), where after thresholding, +1 is assigned for values above threshold +0.2 and −1 for values below −0.2. For values between −0.2 and +0.2, the feature is not significant, e.g., don't care, where for example female=don't care indicating the user may be either female or male. As shown in FIG. 4, other don't care features include ‘Extraverts vs. Introverts or E/I’, ‘Thinkers vs. Feelers or T/F’, ‘Emote vs. Control or E/C’=. The next 2 data points are related to the video portion chosen as a summary of the talk show and include ‘Host’=don't care and ‘Other’=don't care. The next 3 data points are related to the text chosen as a summary of the talk show and include ‘Past’=−1 and ‘Speaker (Guest/Host)’=+1, and ‘Pro/Personal’=+1. The next 3 data points are related to the image chosen as a summary of the talk show and include ‘NumFaces (More than one/one)’=+1 and ‘Intro’=−1, and ‘Guest’=+1.

Thus, in the illustrative case shown in FIG. 4, either a male or female viewer who is a ‘Sensor’ have chosen as a summary that includes more than one face, and guest, and thus prefers content that also includes more than one face, and guest.

2.2.5 Music Video Patterns

Similar analysis was performed to determine patters for music videos, using a concept value matrix (Table 2) having the following columns:

{‘Female’, ‘Age’, ‘E/I’, ‘S/N’, ‘T/F’, ‘J/P’, ‘A/T’, ‘E/C’, ‘Faces’, ‘Text’, ‘Graphics’, ‘Out/In’, ‘Happy/Neutral’, ‘Dark/Bright’, ‘Singer Presence’, ‘Chorus/Other’, ‘Dance/No Dance’, ‘Main Singer/Others’}.

For factor analysis, similar procedure was performed

For the factor analysis, we did a similar procedure eliminating features that had a low variance or that were being pulled as a separate factor and we came up with the following significant factor. We expanded our concept vector and our features were as follows:

{‘Female’, ‘Age’, ‘E/I’, ‘S/N’, ‘T/F’, ‘J/P’, ‘A/T’, ‘E/C’, ‘Auditory’, ‘Left’, ‘Faces’, ‘Text’, ‘Graphics’, ‘Out/In’, ‘Happy/Neutral’, ‘Dark/Bright’, ‘Singer Presence’, ‘Chorus/Other’, ‘Dance/No Dance’, ‘Main Singer/Others’, ‘NoFaces’, ‘OneFace’, ‘ManyFaces’, ‘Text’, ‘Singer/Band’, ‘In/Out’, ‘Bright/Dark’}

Starting with features that had low variance we eliminated the brain bits (Auditory(P) and Left(P)). After eliminating features based on various factors, such as based on one sided correlations, and internal correlations, and low variance, or being independent, for example, the final factor 70 shown in FIG. 7 was obtained, where no significant relations can be inferred.

Now that patterns were obtained based on the concept value matrix (Table 2), for example the patterns shown in FIGS. 3-7, and a mapping is generated between personality and content features.

3. Algorithm

Based on the results obtained from the factor analysis, an algorithm was designed that would generate personalized summaries given the personality type of the user and the input video program.

As seen from the previous sections, a number of significant factors relate personality features to content analysis features. Next, the formulation of summarization algorithm based on these patterns is described.

3.1 Mapping Between Personality and Feature Space

It is desired to generate a mapping between the personality and features. So that given the personality of a person, one can determine what features are preferred and vice versa (given a feature, determine which personalities would like that feature). For each feature, a vector is needed that gives the probability of that feature being liked or disliked by the personality features.

First, factor analysis was performed to get ‘f’ significant factors which are rows of the matrix F shown below. The λ are the factors (or principal components) that are considered significant. λₖ refers to the k^{th} factor of the total of f significant factors that we have for each genre. Each of the factors has a P (personality) part and a V (video feature) part. The P part goes from 1, . . . , q and the V part goes from q+1, . . . , q+w. The λᵢⱼ's are the real valued attributes that are obtained from performing factor analysis above.

$$F = [ \begin{matrix}\overbrace{\begin{matrix}\begin{matrix}{λ}_{11} & {λ}_{12} & ⋯ & {λ}_{1 q}\end{matrix} \\ \begin{matrix}{λ}_{21} & {λ}_{22} & ⋯ & {λ}_{2 q}\end{matrix} \\ ⋮ \\ \begin{matrix}{λ}_{f 1} & {λ}_{f 2} & ⋯ & {λ}_{fq}\end{matrix}\end{matrix}}^{P part} & & \overbrace{\begin{matrix}\begin{matrix}{λ}_{1 , q + 1} & {λ}_{1 , q + 2} & ⋯ & {λ}_{1 , q + w}\end{matrix} \\ \begin{matrix}{λ}_{2 , q + 1} & {λ}_{2 , q + 2} & ⋯ & {λ}_{2 , q + w}\end{matrix} \\ ⋮ \\ \begin{matrix}{λ}_{f , q + 1} & {λ}_{f , q + 2} & ⋯ & {λ}_{f , q + w}\end{matrix}\end{matrix}}^{V part}\end{matrix} ]$$

Second, the factors are thresholded to yield a value of +1 or −1 as following, where 0 is 0.2 for example:

$${\overline{λ}}_{ij} = \{ \begin{matrix}1 & if {λ}_{ij} > θ \\ - 1 & if {λ}_{ij} < - θ \\ 0 & Otherwise\end{matrix}$$

This results in a matrix that has only 1, −1, and 0.

For example, the final factor (shown as numeral 70 in FIG. 7) for the music video data is represented by one row of matrix F shown above. The final factor for music video data shown in FIG. 7, includes 5 personality traits (Female/Male (F/M), E/I, S/N, T/F, and E/C) and 6 video features (Text, Dark/Bright (D/B), Chorus/Other (C/O), Main singer/Other (S/O), Text (for still images), Indoor/outdoor (I/O) as noted in the first row of Table 3. The second row of Table 3 is one row of matrix F before and after thresholding, respectively.

TABLE 3

| F/M | E/I | S/N | T/F | E/C | Text | D/B | C/O | S/O | Text | I/O |
|---|---|---|---|---|---|---|---|---|---|---|
| −0.15 | −0.18 | −0.15 | 0.18 | −0.21 | 0.38 | −0.28 | 0.21 | 0.72 | 0.98 | −0.52 |
| 0 | 0 | 0 | 0 | −1 | 1 | −1 | 1 | 1 | 1 | −1 |

Thus, for example, Control type personalities (E/C=−1) like chorus (Chorus/Other=+1) in a music video.

Third, the general personality P vector (p₁, . . . , p_{q}) is associated with the general video feature V vector (v₁, . . . , v_{w}) via matrix A shown below, thereby showing how video features are related to the personalities.
V=AP

where, the matrix A is as follows:

$$A = [ \begin{matrix}\begin{matrix}{a}_{11} & {a}_{12} & ⋯ & {a}_{1 q}\end{matrix} \\ \begin{matrix}{a}_{21} & {a}_{22} & ⋯ & {a}_{2 q}\end{matrix} \\ ⋮ \\ \begin{matrix}{a}_{w 1} & {a}_{w 2} & ⋯ & {a}_{wq}\end{matrix}\end{matrix} ]$$

The rows in matrix A are the personality bits 1 to q, while the columns are the video or content bits 1 to w. That is, the weights in matrix A referred to as aᵢⱼ in the above equation relate each of the w content features to the q personality features. For example, if visual feature 5 (i=5), is liked by the personality feature 2 (j=2), then a₅₂ will be 1 (where −1 indicates ‘not like’ and zero indicates ‘don't care’ i.e., can be either or (e.g., like or dislike)). These weights are derived as follows:

$${a}_{ij} = {\sum }_{k = 1}^{f} {\overline{λ}}_{( i + q ) k} {\overline{λ}}_{jk}$$

What is modeled above is that for factors that are significant, if a certain personality feature (subscript j) and video analysis feature (subscript i) are both positively significant, then a_{i,j} is incremented by 1. This means that a given personality feature favors the given video feature. However, if the signs are opposing in the factor, then a_{i,j} is decremented by −1 meaning that the personality feature does not favor the given video feature.

For example, as seen from Table 3, Control type personalities (E/C=−1) like chorus (Chorus/Other=+1) in a music video. Thus, for this personality trait and content feature:
aᵢⱼ=(+1)(−1)=−1

The matrix A gives a mapping of different features to personality. It should be noted that the transpose of this matrix, A′ gives a mapping of personality to different features.

3.2 Classification of Video Segment Based on Personality

Next, video segments are classified based on personalities that would like particular video segments. For example, as noted above, from Table 3, it is seen that Control type personalities (E/C=−1) like chorus (Chorus/Other=+1) in a music video. This information is computed as a personality classification vector C_{P}.

Thus, once the mapping between features and personality is computed, then the personality classification vector C_{P} for video segments is computed. Having personality classification for video segments is useful for generating personalized multimedia summaries, for generating recommendations based on user's personality, and for retrieving and indexing media according to user's personality type.

In particular, as shown in FIG. 8 a flow chart 80 for recommending content includes determining 110 personality attribute(s) of a user; extracting 120 content feature(s) of the content; applying 130 the personality attribute(s) and the content feature(s) to a map that includes an association between the personality attribute(s) and the content feature(s) to determine preferred feature(s) of the user; and recommending at least one program content that includes the preferred feature(s). The applying act (130), for example, personalizes summary by ranking the content features in accordance to importance to the user, where the preferred feature(s) include content feature(s) having a higher rank than other features of the content. The importance may be determined using the map.

FIG. 9 shows a method 200 for generating the map which includes the following acts for example: taking (210) by test subjects at least one personality test to determine personality traits of the test subjects; observing (220) by the test subjects a plurality of programs; choosing (230) by test subjects preferred summaries for the plurality of programs; determining (240) test features of the preferred summaries; and associating (250) the personality traits with the test features.

In order to generate the “personality type” of a video segment, the different video/audio/text analysis features are generated for that segment (V_{wx1}). This vector contains information whether a feature is present or not for each of the features in a video segment. Given the personality mapping matrix A_{wxq}, the personality classification (cₚ) for each segment is derived as below:
C_{P}_{_{qx1}}=(cp₁, cp₁, . . . cp_{q})′=A′_{qzw}V_{wx1}

The above equation maps different personalities onto the video segments.

3.3 Personalized Summarization Algorithm

Once the feature to personality mapping is obtained, personalized summaries can be generated. The personalized summarization can be implemented in one of two ways.

1. Map the features in a video segment to personality based on the A, and apply to this the personality profile in order to filter to the video segments; or

2. Map a personality to features based on the A′ and apply this as a filter to the video segments.

For the first case, the following enumerates the generation of personalized summaries:

1. Given mapping matrix A_{wxq},

2. Given feature vector V_{wx1} which says whether a feature is present or not for each of the features in a video segment,

3. Given a user profile U_{qx1} which gives the personality mapping,

4. Compute the personality classification vector Cₚ for a video segment as described above, namely:
C_{P}_{_{qx1}}=(cp₁, cp₁, . . . , cp_{q})′=A′_{qxw}V_{wx1}

5. Compute the importance I of the above classification vector for the user profile as a dot product between C and U.
I=U·Cₚ

Each segment receives a score from each feature and the scores are summed up.

6. For all the segments S₁, . . . , Sₜ of the video, compute the importance I₁, . . . , Iₜ.

7. Finally select the segments starting from the highest importance till the duration of the selected segments is less than a predefined threshold.

For the second case, namely mapping a personality to features based on the A′ and applying this as a filter to the video segments:

1. Given mapping matrix A_{wxq},

2. Given feature vector V_{wx1} which says whether a feature is present of not for each of the features in a video segment;

3. Given a user profile U_{qx1} which gives the personality mapping,

4. Compute the video classification vector C_{V} for the profile vector
C_{V}_{_{wx1}}=(cv₁, cv₂, . . . , cv_{w})′=A_{wxq}W_{qx1}

5. The above equation maps different video features onto the personality profile of the user.

6. Compute the importance I of the above classification vector for the mapped user profile as a dot product between C and V.
I=V·C_{V}

7. For all the segments S₁, . . . , Sₜ of the video, compute the importance I₁, . . . , Iₜ.

8. Finally select the segments starting from the highest importance till the duration of the segments selected is less than a predefined threshold.

The two approaches are more or less equivalent. However, in the second approach the mapping is done only once for the user profile. This reduces the complexity of the computations. So that for every new video that is analyzed, there is no need to map the features into personality space.

3.4 Content Recommendation

By generating the personality classification for each video as described in section 3.2, in essence the whole video is classified. If a video happens to have more segments that appeal to a certain personality type, for example, Extravert, then that video (movie, sitcom, etc.) can be recommended to the user who is an Extravert. This greatly simplifies the recommenders that are state of the art today, which require a detailed history of programs watched by the user, and build up a profile based on keywords derived from the program guide data and match this to the new content.

3.5 Usage Scenarios

The automatic generation of personalized summaries can be used any electronic device 300, shown in FIG. 10, having a processor 310 which is configured to generated personalized summaries and recommendation of summaries and or content as described above. For example, the processor 310 may be configure to determine personality attributes of a user of content; extract features of the content; and generate personalized summary based on a map of the features to the personality attributes. For example, the electronic device 300 may be a television, remote control, set-top box, computer or personal computer, any mobile device such as telephone, or an organizer, such as a personal digital assistant (PDA).

Illustratively, the automatic generation of personalized summaries can be used in the following scenarios:

1. The user of the application interacts with a TV (remote control) or a PC, to answer a few basic questions about their personality type (using any personality test(s) such as the Myer-Briggs test, Merrill Reid test, and/or brain.exe test, etc.). Then the summarization algorithm described in section 3.3 is applied either locally or at a central server in order to generate a summary of a TV program which is stored locally or available somewhere on a wider network. The personal profile can be further stored locally or at a remote location.

2. The user of the application interacts with a mobile device (phone, or a PDA) in order to give input about their personality. The system performs the personalized summarization somewhere in the network (either at a central server or a collection of distributed nodes) and delivers to the user personalized summaries (e.g. multimedia news summaries) on their mobile device. The user can manage and delete these items. Alternatively the system can refresh these items every day and purge the old ones.

3. The personalization algorithm can be used as a service as part of a Video on Demand system delivered either through cable or satellite.

4. Personalization algorithm can be part of any video rental or video shopping service either physical or on the Web. The system can help the users in recommending video content they will like by providing personalized summaries

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method of generating a personalized summary of content for a user comprising:
determining (110) personality attributes of said user;
extracting (120) features of said content; and
generating (140) said personalized summary based on a map of said features to said personality attributes.

2. The method of claim 1, further comprising:
ranking said features based on said map and said personality attributes;
wherein said personalized summary includes portions of said content having said features which are ranked higher than other of said features.

3. The method of claim 1, wherein generation of said personalized summary includes varying importance of segments of said content, based on said features preferred by persons having said personality attributes as determined from said map.

4. The method of claim 1, wherein said map includes an association of said features with said personality attributes.

5. The method of claim 1, wherein said map includes a classification of said features that are preferred by persons having said personality attributes.

6. The method of claim 1, wherein generation of said map includes:
taking (210) by test subjects at least one personality test to determine personality traits of test subjects;
observing (220) by said test subjects a plurality of programs;
choosing (230) by said test subjects preferred summaries for said plurality of programs;
determining (240) test features of said preferred summaries; and
associating (250) said personality traits with said test features.

7. The method of claim 1, wherein generation of said map comprises:
determining personality traits of test subjects;
observing programs by said test subjects;
choosing tests summaries by said test subjects;
extracting test features from said tests summaries; and
forming a content matrix that associates said test features with said personality traits.

8. The method of claim 7, further comprising analyzing said content matrix using factor analysis.

9. The method of claim 1, wherein said personality attributes are determined using at least one of Myers-Briggs Type Indicator test, Merrill Reid test and brain-use test.

10. A computer program embodied within a computer-readable medium created using the method of claim 1.

11. A method of recommending contents to a user comprising:
determining (110) personality attributes of said user;
extracting (120) content features of said contents;
applying (130) said personality attributes and said content features to a map that includes an association between said personality attributes and said content features to determine preferred features of said user; and
recommending (150) at least one of said contents that includes said preferred features.

12. The method of claim 11, wherein said applying ranks said content features in accordance to importance to said user, said preferred features including content features having a higher rank than other of said content features.

13. The method of claim 12, wherein said importance is determined using said map.

14. A computer program embodied within a computer-readable medium created using the method of claim 11.

15. An electronic device (300) comprising a processor (310) configured to determine (110) personality attributes of a user of content; extracting (120) features of said content; and generating (140) personalized summary based on a map of said features to said personality attributes.

16. An electronic device (300) for recommending contents to a user comprising a processor (310) configured to determine (110) personality attributes of said user; extract (120) content features of said contents; apply (130) said personality attributes and said content features to a map that includes an association between said personality attributes and said content features to determine preferred features of said user; and recommend (150) at least one of said contents that includes said preferred features.
